(19) United States
(12) Patent Application Publication
(10) Pub. No.: US 2002/0152430 A1
(43) Pub. Date: Oct. 17, 2002

(54) Device troubleshooting via network

(75) Inventors: Yoshihiko Akasaka, Nagano-ken (JP); Kei Sato, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/112,032

(22) Filed: Apr. 1, 2002

(30) Foreign Application Priority Data
Mar. 30, 2001 (JP) 2001-99668(P)

(51) Int. Cl. H04B 1/74

(52) U.S. Cl. 714/43

(57) ABSTRACT

When the user selects an element for specifying a desired troubleshooting procedure on a troubleshooting page displayed by the browser of a client 200, the client 200 issues a request for a server system 110 or 120 to transmit a troubleshooting program. The server system 110 or 120 transmits the troubleshooting program in accordance with the transmission request. After being downloaded, the troubleshooting program is automatically started and a troubleshooting procedure is performed on the client 200.

### BACKGROUND OF THE INVENTION

1. Field of the Invention

The present invention relates to a technique for troubleshooting devices in a client/server network environment.

2. Description of the Related Art

A personal computer may be connected to a printer, a scanner, and other types of peripheral devices via external interfaces. In conventional practice, a manual supplied with each type of peripheral devices must be consulted if the peripheral devices develops malfunctions or breaks down. In recent years, numerous user support pages for providing support to users through the Internet have become available from companies that manufacture or market such peripheral devices. The support pages contain detailed troubleshooting instructions for the peripheral devices of these companies.

It is, however, fairly inconvenient to examine manuals or user support pages in order to troubleshoot peripheral devices or client devices, and the average user often finds it difficult to understand the meaning of such troubleshooting measures. In other words, conventional techniques are disadvantageous in that they make troubleshooting inconvenient and difficult for users.

### SUMMARY OF THE INVENTION

Accordingly an object of the present invention is to provide a technique that can simplify perform troubleshooting of peripheral devices or client devices.

The network system includes a client device and a server system connected via a network. The server system stores a troubleshooting Web page containing troubleshooting instruction elements, which allow users to input instructions to execute troubleshooting procedures in order to troubleshoot the peripheral device or the client itself. The server system also stores a troubleshooting program to be executed by the client for the troubleshooting procedures. Upon request from the client, the server system transmits the troubleshooting page to the client, and the browser on the client displays the troubleshooting page. The client transmits a request of a troubleshooting program to the server system in response to selection of one of the troubleshooting instruction element. The server system transmits the troubleshooting program to the client in accordance with the transmission request. The client carries out the troubleshooting procedures by executing the troubleshooting program transmitted from the server system.

With this system, the user of the client can easily troubleshoot the peripheral device or the client, without having detailed knowledge about the client or the peripheral device because a troubleshooting program suitable for the device is executed by the client after being transmitted there from the server system when the troubleshooting instruction element is selected on the troubleshoot page.

The present invention can be implemented in a variety of ways, examples of which include: a method and network system for executing troubleshooting procedures for peripheral devices or clients, a server system or client therefor; a computer program for causing a computer to perform the functions of the method, the server system, and/or the client device; a computer program product having a computer readable medium storing the computer program; and a data signal embodied in a carrier wave containing the computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a diagram depicting the overall structure of a user support system as a embodiment of the present invention;

FIG. 2 is a flowchart depicting a printer user support procedure provided by a support center 100;

FIG. 3 is a diagram depicting a printer FAQ page 114;

FIG. 4 is a diagram depicting a printer auto-check menu;

FIG. 5 is a flowchart depicting a routine for nozzle check pattern printing;

FIG. 6 is a diagram depicting a page used to warn that the browser does not support the troubleshooting procedure;

FIG. 7 is a diagram depicting a start page for nozzle check pattern printing;

FIG. 8 is a block diagram depicting a auto execution module 300 for nozzle check pattern printing;

FIG. 9 is a diagram depicting a page for issuing a warning that the printer type is not supported by the troubleshooting procedure;

FIG. 10 is a diagram depicting a page for issuing a warning that an “out of ink” error has been detected;

FIG. 11 is a diagram depicting a dialog box containing printing options for the nozzle check pattern;

FIG. 12 is a flowchart depicting the routine for a general printer check;

FIG. 13 is a start page for the general printer check;

FIG. 14 is a block diagram depicting a auto execution module 400 for a general printer check;

FIG. 15 is a diagram depicting a page for issuing a warning that a paper jam error has been detected;

FIG. 16 is a diagram depicting an example of the page used to indicate that a general check has been completed;

FIG. 17 is a flowchart depicting the procedure for the auto-installation of a printer driver;

FIG. 18 is a block diagram depicting a auto-installation module 500 at a time when the auto-installation of a printer driver is started; and

FIG. 19 is a block diagram depicting the auto-installation module 500 after the setup module of the printer driver has been downloaded.

### DESCRIPTION OF THE PREFERRED EMBODIMENT

Embodiments of the present invention will now be described through embodiments in the following sequence.

A. Overall System Structure

B. Nozzle Check Pattern Printing

C. General Printer Check

D. Auto-installation of Printer Driver

E. Modifications

A. Overall System Structure

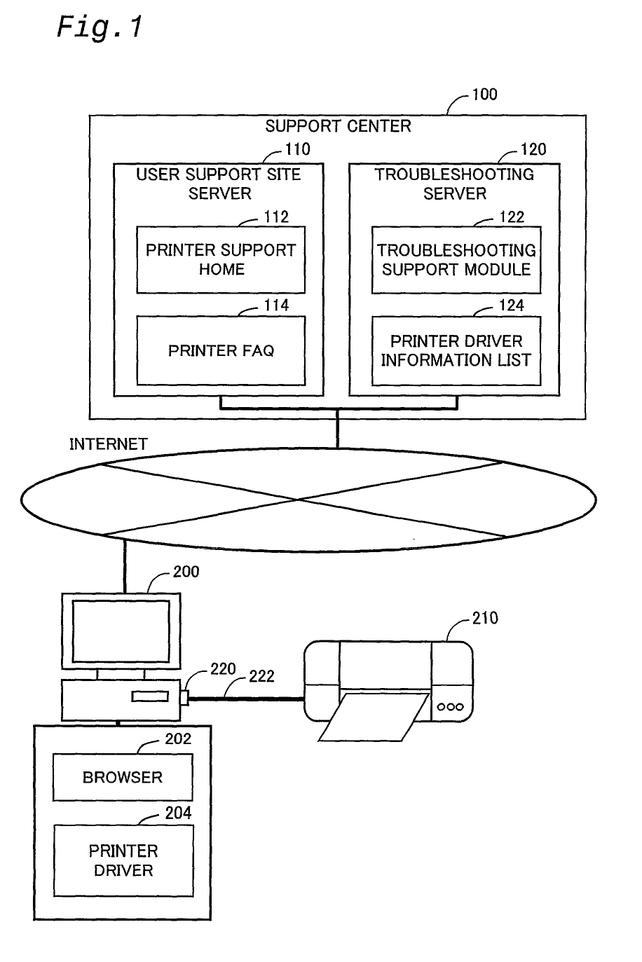

FIG. 1 is a diagram depicting the overall structure of a user support system as a embodiment of the present invention. The system comprises a support center 100 and a client computer 200 connected via the Internet.

The support center 100 comprises a user support site server 110 and a troubleshooting server 120. The user support site server 110 is a WWW server for supplying user support information about printers, scanners, and other types of peripheral devices. The troubleshooting server 120 is a server used for troubleshooting the peripheral devices. The two servers 110 and 120 may be separate pieces of computer hardware or a single piece of computer hardware. Alternatively, a single server may provide the service offered by the two servers 110 and 120.

The two servers 110 and 120 contain files or program modules for supporting printer users. Specifically, the user support site server 110 stores various Web pages containing a printer support home page 112 and a printer FAQ page 114, whereas the troubleshooting server 120 stores a troubleshooting support module 122 and a printer driver information list 124. These files or modules will be described later in detail.

A printer 210 is connected to the client computer 200 through a parallel port 220 and a cable 222. A browser 202 and a printer driver 204 may be installed on the client computer 200. The client computer 200 will be referred to hereinbelow merely as a “client.”

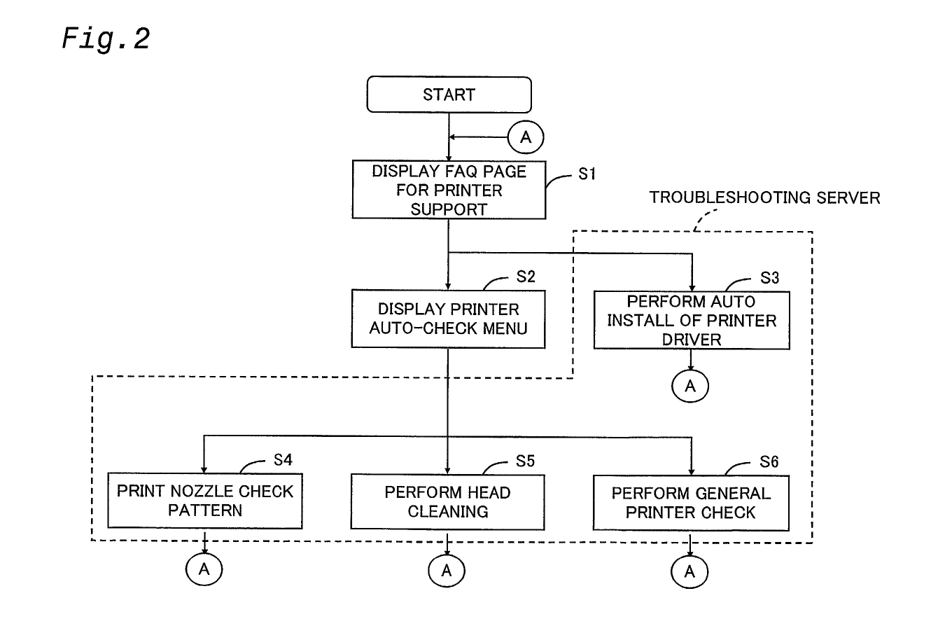

FIG. 2 is a flowchart depicting a printer user support procedure provided by the support center 100. In step S1, the printer FAQ page 114 is transmitted to the client 200 from the user support site server 110 in accordance with a request from the client 200, and displayed by the browser 202.

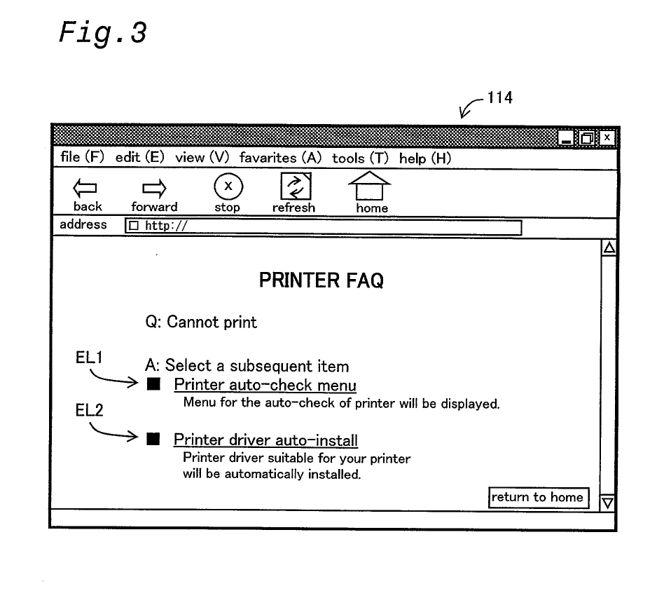

FIG. 3 is a diagram depicting the printer FAQ page 114. It is a so-called FAQ (frequently asked questions) Web page. A first element EL1 labeled “Printer auto-check menu,” and a second element EL2 labeled “Printer driver auto-installation” are selectively displayed on this page as answers to the query “Q. Cannot print”

As used herein, the term “element” refers to an item on a Web page (occasionally referred to merely as a “page”) or dialog (also referred to as a “dialog box”). Buttons, character strings, images, menus, and other items may be used as such elements.

A page with a printer auto-check menu is displayed (step S2 in FIG. 2) after being transmitted from the server 110 if the user of the client 200 selects the first element EL1 on the page shown in FIG. 3. A printer driver is auto-installed if the user selects the second element EL2 (step S3). The auto-installation of the printer driver is described later.

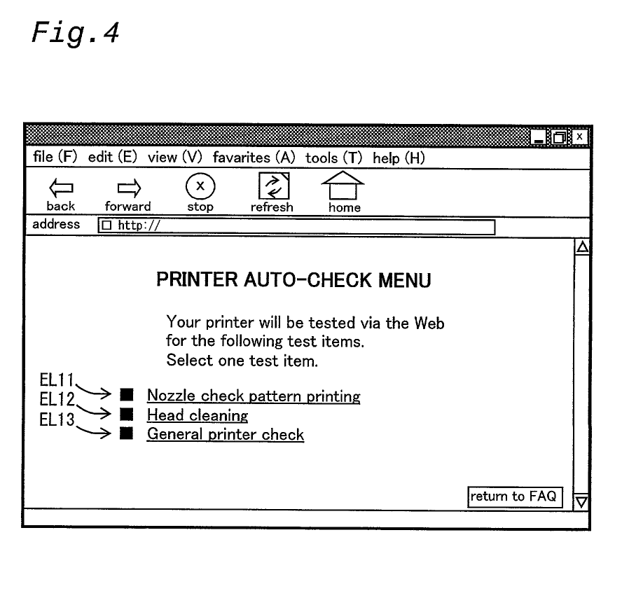

FIG. 4 is a diagram depicting a printer auto-check menu. A first element EL11 labeled “Nozzle check pattern printing,” a second element EL12 labeled “Head cleaning,” and a third element EL13 labeled “General printer check” are selectively displayed on this page. The desired troubleshooting procedure is performed when the corresponding element is selected (steps S4-S6 in FIG. 2).

The troubleshooting procedure of steps S3-S5 is performed with support from the troubleshooting server 120. Specifically, the elements EL2 (FIG. 3) and EL11-EL13 (FIG. 4) for identifying the troubleshooting procedure are linked to the associated troubleshooting support module 122.

The nozzle check pattern printing (step S4), general printer check (step S6), and printer driver auto-installation (step S3) will now be described in detail in this order.

B. Nozzle Check Pattern Printing

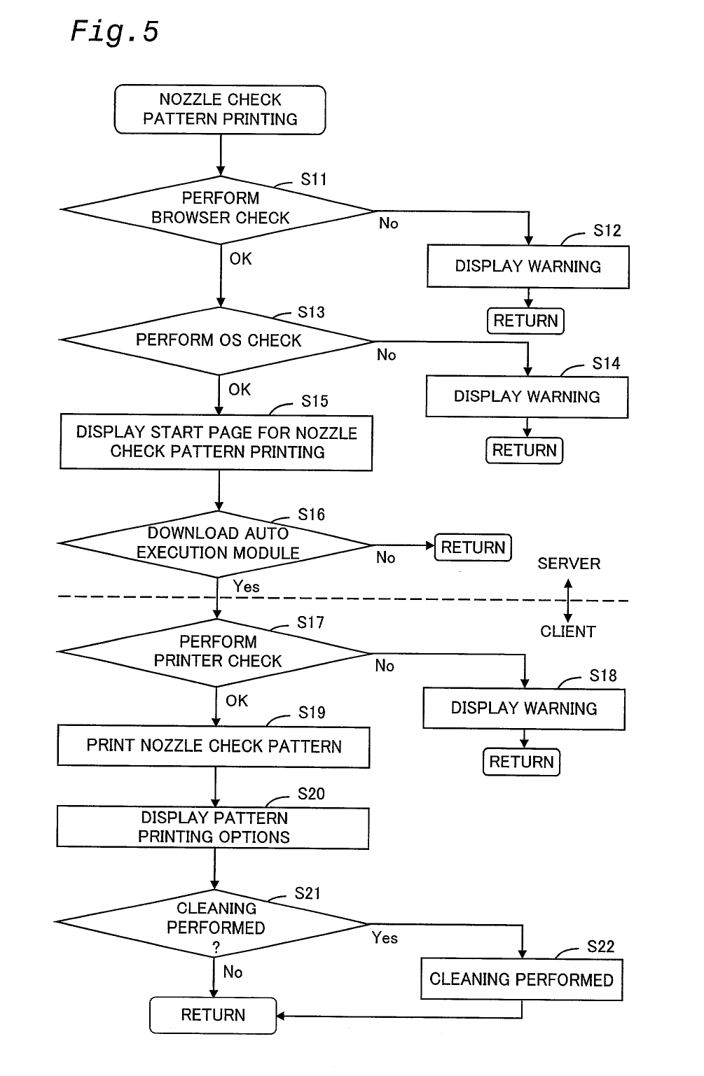

FIG. 5 is a flowchart depicting a routine for nozzle check pattern printing. Of the steps S11-S22 in FIG. 5, steps S11-S16 are primarily executed by the troubleshooting server 120, and steps S17-S22 are primarily executed by the client 200.

When the user selects the first element EL11 in FIG. 4, the troubleshooting support module 122 in the server 120 identifies the type and version of browser 202 (FIG. 1) and the type and version of the operating system on the client 200, and determines whether the browser and the operating system support the available troubleshooting (steps S11 and S13 in FIG. 5). Information about the browser 202 (FIG. 1) and information about the operating system of the client 200 are transmitted to the server 120 from the browser 202 when the element EL11 is selected.

Version 4.01 or higher of Internet Explorer (registered trade mark of Microsoft Corporation), or version 4.0 or higher of Netscape Navigator (registered trade mark of Netscape Communications Corporation) can be used as the browser 202 capable of supporting the troubleshooting procedures. Windows 95 and Windows 98 (both are registered trade marks of Microsoft Corporation) can be cited as examples of the operating system for the client 200.

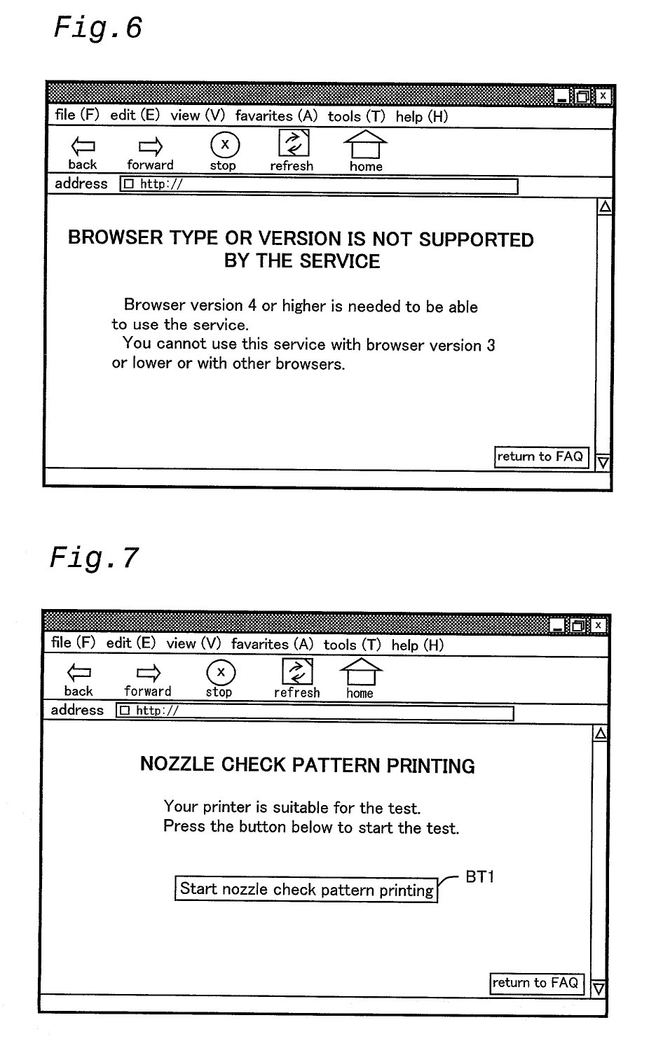

If the browser or operating system are not suitable for the troubleshooting procedure, a warning to that effect is transmitted from the server 120 to the client 200 and is displayed on the screen of the client 200 (steps S12, S14). FIG. 6 shows a page used to warn that the browser is not suitable for the troubleshooting procedure.

Determining whether the browser or operating system is suitable at the start of troubleshooting makes it possible to stop the troubleshooting procedure if the browser or operating system is deemed to be inappropriate. The resulting advantage is that unneeded procedures can be avoided both on the side of the server 120 and on the side of the client 200.

If the browser or operating system is deemed suitable, the page for starting nozzle check pattern printing shown in FIG. 7 is displayed after being transmitted from the server 120 to the client 200 (step S15). The page contains a button BT1 labeled “Start nozzle check pattern printing.” When the user clicks the button BT1, a request is sent from the client 200 to the server 120 to transmit a auto execution module for printing the nozzle check pattern, and the troubleshooting support module 122 transmits the auto execution module to the client 200 (step S16).

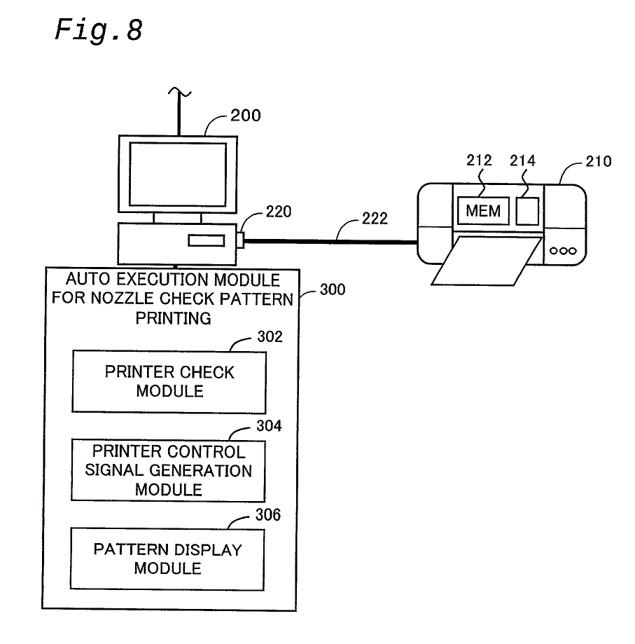

FIG. 8 is a block diagram depicting an auto execution module 300 downloaded to the client 200. The auto execution module 300 comprises the following three modules: a printer check module 302, a printer control signal generation module 304, and a pattern display module 306. The indicated classification of the modules 302, 304, and 306 in the auto execution module 300 is used for the sake of convenience, and different configuration may also be used for the makeup of the auto execution module 300. It is also possible for the entire auto execution module 300 to be composed of a single module.

As used herein, the term “module” is synonymous with “program.” The term “program” has a broad meaning that includes “script.”

The auto execution module 300 is automatically started when the downloading of the module to the client 200 is completed. The auto execution module 300 may, for example, be created using Active X technology (trademark of Microsoft Corporation).

When the auto execution module 300 is mounted using Active X technology, the server 110 or 120 may, for example, be a Windows NT Server (trademark of Microsoft Corporation) or an IIS (Internet Information Server; trademark of Microsoft Corporation). The Web pages may be ASP (Active Server Pages; trademark of Microsoft Corporation) or JSP (Java Server Pages; trademark of Sun Microsystems Incorporated). Using ASP or JSP makes it possible to create dynamic pages with ease. The Web pages can be created with even greater ease by the use of COM (Component Object Model; trademark of Microsoft Corporation) components for the ASP.

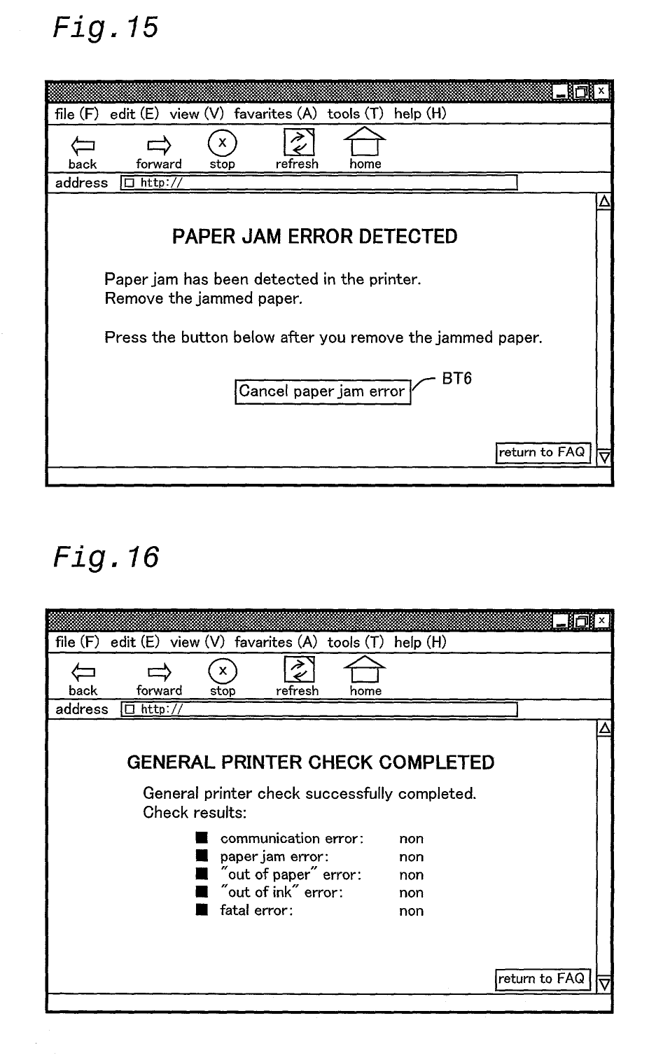

The printer check module 302 identifies for the following check items for the printer 210 in step S17 (FIG. 15).

(1) Type of printer 210

(2) Communication error message (first error state)

(3) Paper jam error message (second error state)

(4) “Out of paper” error message (third error state)

(5) “Out of ink” error message (fourth error state)

(6) Fatal error message (fifth error state)

(7) Maintenance error message (sixth error state)

Check item (1) is identified by reading the vendor ID and product ID (device ID) registered in the memory 212 of the printer 210 (FIG. 8). Check items (2) to (7), which indicate printer error states, are identified by reading the error message information stored in the memory 212. The error message information is created with the aid of the control circuits (not shown) of the printer 210. A communication error message denotes a faulty connection between the client 200 and the printer 210. A fatal error message denotes a serious malfunction that needs to be handled by shipping the printer 210 to a service facility. An “out of ink” error message is generated based on the remaining ink amount stored in a memory 214 provided to the ink cartridge (not shown) of the printer 210. The maintenance error message is a message indicating that the printer 210 is approaching its next necessary maintenance time.

In order to identify these check items (1) to (7), the printer control signal generation module 304 presents the printer 210 with a control signal requesting information about these check items in accordance with the instructions provided by the printer check module 302. When the requested information about the check items is returned by the printer 210, the printer check module 302 reads this information and identifies the check items (1) to (7).

The control signal is transmitted to the printer 210 by the printer control signal generation module 304 without the agency of the printer driver 204. The reason why this type of transmission is made possible is because the printer 210 is directly connected to the external interface (parallel port 220) of the client 200. The same procedure can be performed by setting a protocol for exchanging control signals via a LAN or other network when the client 200 and printer 210 are connected via the network.

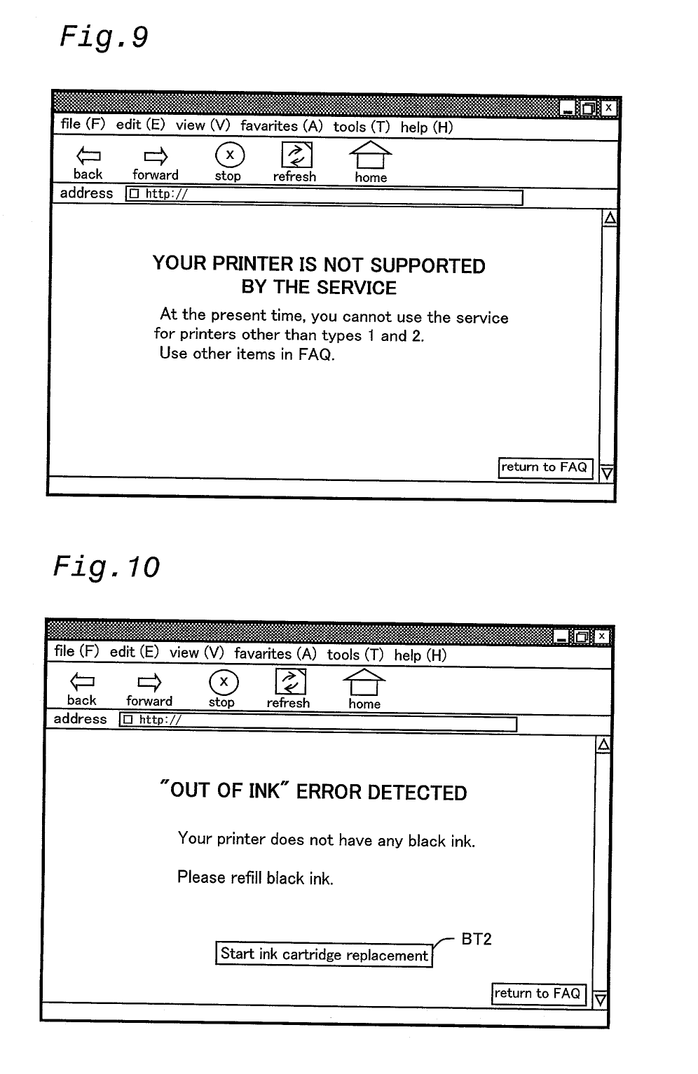

When the check result indicates a problem with any of the check items, a Web page or dialog box with a corresponding warning is displayed on the screen of the client 200 (step S18 in FIG. 5). FIG. 9 depicts a page for issuing a warning that the printer type is not supported by the troubleshooting procedure. FIG. 10 depicts a page for issuing a warning that an “out of ink” error has been detected. The page shown in FIG. 10 contains a button BT2 labeled “Start ink cartridge replacement.” When the button BT2 is clicked, a control signal indicating that the ink cartridge is to be replaced is sent from the printer control signal generation module 304 to the printer 210, and the printer 210 starts replacing the ink cartridge in accordance with the signal. Specifically, a carriage (not shown) mounted with an ink cartridge moves substantially to the center of the printer 210 to a position in which the user can replace the cartridge. In this case, the printer 210 operates in the same manner as when the user manually depresses a pushbutton provided to the front panel of the printer 210 and designed to initiate ink replacement.

It can be seen from the example related to such an “out of ink” error that when an error state is identified in accordance with the error information stored in the printer 210, a page or dialog box containing an element (button BT2 in FIG. 10) for indicating the start of a troubleshooting procedure designed to allow the system to recover from this error state is displayed on the screen of the client 200 in accordance with the present embodiment. Consequently, the user can click on this element to allow the printer 210 to perform operations aimed at overcoming the current error state of the printer 210.

In some error states, however, it is impossible to cause the printer 210 to perform operations aimed at overcoming the current error state. For example, a communication error cannot be corrected by providing the printer 210 with a control signal. In such cases, the type of error state is displayed on the screen of the client 200, but the display lacks an element that would specify the procedure to be used to overcome the error. In these cases as well, a textual or pictorial description should preferably be displayed in order to allow this error state to be corrected. Based on this display, the user can monitor the error state of the printer 210 and to address the problems of the printer 210 in accordance with the results of such monitoring.

Since the type of printer used and the error state are identified by the client 200 alone, there is no need to send information about the printer type or error state to the server 110 or 120. The printer type and/or error state can be conveyed as personal information about user preferences with respect to the printer 210. This approach is highly advantageous in that such personal information does not need to be provided to the server 110 or 120.

A control signal specifying that a nozzle check pattern is to be printed is presented by the printer control signal generation module 304 to the printer 210 if no problems are encountered with the check items (step S19 in FIG. 5). The printer 210 prints a specific nozzle check pattern in accordance with the results. Print data representing the nozzle check pattern is stored in advance in the memory 212 (FIG. 8) of the printer 210. The printer control signal generation module 304 therefore only needs to send to the printer 210 a control signal instructing to start the printing of the nozzle check pattern. Alternatively, the module 304 may send the print data of the nozzle check pattern to the printer 210. In another embodiment, the printer driver 204 (FIG. 1) may provide the printer 210 with the control signal and/or the print data of the nozzle check pattern, in place of the printer control signal generation module 304. When the printing of the nozzle check pattern is completed, a signal containing the corresponding notification sent by the printer 210 to the client 200, and the pattern display module 306 displays a Web page or a dialog box printing examples of the nozzle check pattern (step S20).

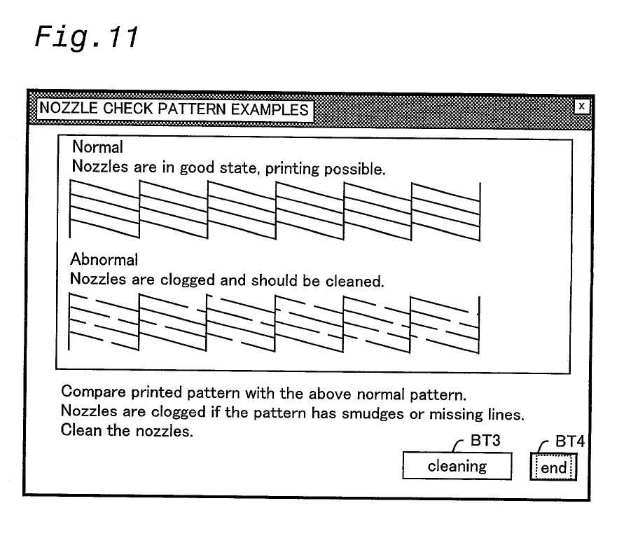

FIG. 11 is a diagram depicting a dialog box containing printing examples of the nozzle check pattern. Examples of normal nozzle check patterns and abnormal nozzle check patterns are displayed in the dialog box, which contains a “cleaning” button BT3 and an “end” button BT4. When the user clicks the cleaning button BT3, a control signal indicating the start of a cleaning operation is sent from the printer control signal generation module 304 to the printer 210. The printer 210 starts the cleaning operation in accordance with the transmission (steps S21, S22). As a result, the clogging of nozzles can be cleared and the printer 210 returned to its normal operating state.

Clicking the end button BT4 on the screen shown in FIG. 11 ends the procedure shown in FIG. 5 and causes the page shown in FIG. 3, a FAQ top page, or another specific Web page to be displayed after being transmitted from the server 110 to the client 200.

When the user clicks the element (button BT1) for indicating the start of nozzle check pattern printing on the Web page (FIG. 7) in accordance with the procedure of FIG. 5 in this manner, the corresponding auto execution module 300 (FIG. 8) is first downloaded from the troubleshooting server 120 (FIG. 1) to the client 200, and the auto execution module 300 then sends a control signal to the printer 210, whereby nozzle check pattern printing is started. The user can therefore allow the printer 210 to print the nozzle check pattern designed for this printer 210 just by clicking an element on a Web page. In other words, procedures designed to deal with any malfunctions or breakdowns occurring in the printer 210 can be readily performed without the user reading the manual for the printer 210 and operating the buttons on the printer 210 or executing a printer utility on the client 200.

When the nozzle check pattern has been printed in the manner shown in FIG. 11, normal and abnormal examples are both displayed on the screen of the client 200, allowing the user to easily analyze the printed results by observing the screen. Since the screen contains an element (cleaning button BT3) for identifying the type of subsequent troubleshooting procedure to be performed in the case of abnormal results, the benefit for the user is that this element can be used to allow the client 200 and the printer 210 to perform this procedure.

When the user clicks the second element EL12 in FIG. 4, head cleaning is performed as a troubleshooting procedure. The overall procedure for the head cleaning is substantially identical to the one shown in FIG. 5 above. This head cleaning is different, however, in that a cleaning operation is performed instead of the nozzle check pattern printing in step S19 of FIG. 5, and steps S20-S22 are dispensed with. It is also possible to use a procedure in which a nozzle check pattern is printed following the head cleaning. In this case, it is preferable, for example, to display on the screen of the client 200 a page or dialog box containing a notification about the completion of head cleaning, and an element for instructing to start printing of a nozzle check pattern when the head cleaning operation is completed. It is also possible to perform steps S19-S20 in FIG. 5 after the printing of the nozzle check pattern has been performed.

C. General Printer Check

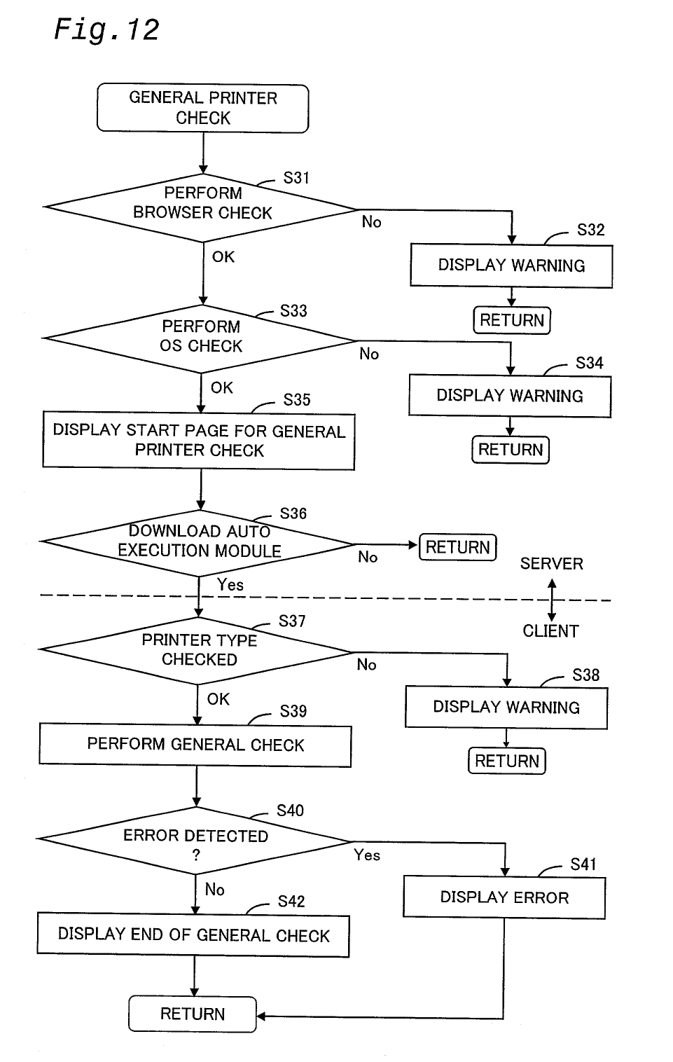

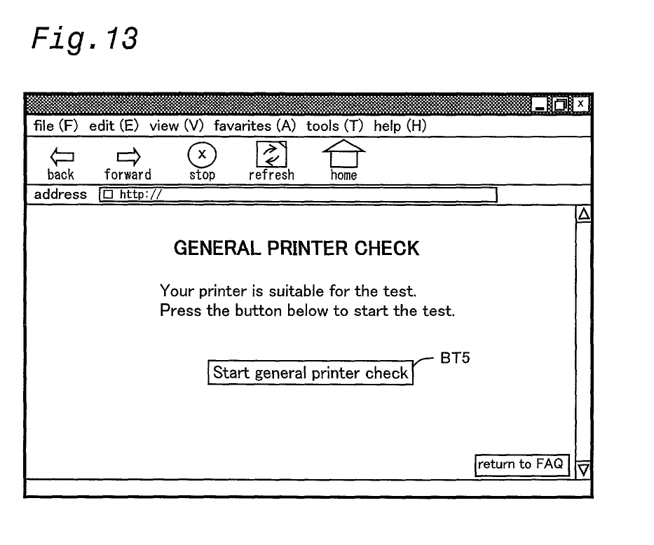

FIG. 12 is a flowchart depicting the routine for a general printer check. The procedure starts with the user clicking the third element EL12 in FIG. 4. Steps S31-S34 in FIG. 12 are the same as steps S11-S14 in FIG. 5. In step S35, the start page for the general printer check, shown in FIG. 13, is displayed after being transmitted from the server 120 to the client 200. When the user clicks a button BT5, the troubleshooting support module 122 of the server 120 (FIG. 1) transmits an auto execution module for performing the general printer check to the client 200 (step S36).

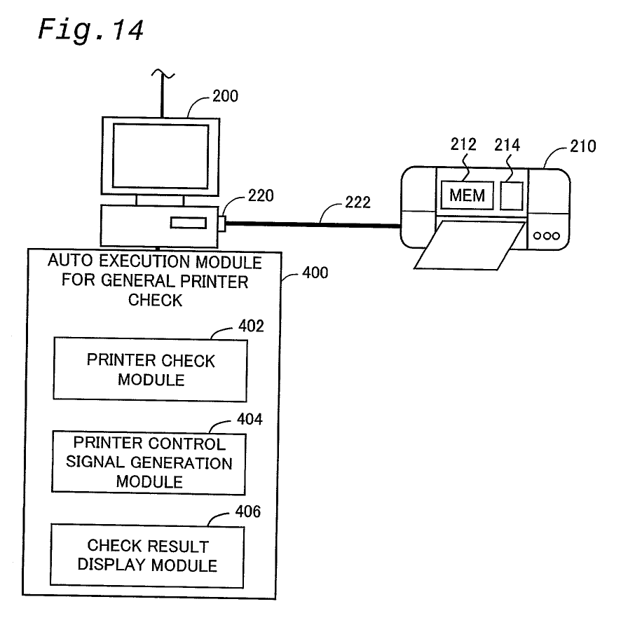

FIG. 14 is a block diagram depicting an auto execution module 400 downloaded to the client 200. The auto execution module 400 comprises a printer check module 402, a printer control signal generation module 404, and a check result display module 406. The auto execution module 400 is automatically started when its downloading to the client 200 is completed.

In step S37, the type of printer 210 is identified by the printer check module 402. If the printer 210 is not suitable for this general printer check, a warning is issued to this effect (step S38).

In step S39, the printer check module 402 performs a general check on the printer 210. Of the six check items checked in step S17 of FIG. 5, the five items (2) to (6) for indicating the error states of the printer 210 are subject to this general check. It is also possible to perform a check that includes other items, or to dispense with some of the five items (2) to (6).

If the printer 210 is in an error state, the Web page or dialog box designed to inform about the existence of this error state is displayed on the screen of the client 200 (step S41). FIG. 15 is an example of a page designed to inform that a paper jam error has been detected. The page contains a “Cancel paper jam error” button BT6.

If the user clicks button BT6 in FIG. 15 after removing the jammed paper, the printer control signal generation module 404 sends a signal to delete the paper jam error information registered in the memory 212 inside the printer 210 to the printer 210 via the parallel port 220. As a result, the printer 210 returns to a regular state that allows printing to be performed. In the case of an “out of ink” error message, the same page as the one shown in FIG. 10 above is displayed on the screen of the client 200.

When no error is detected in step S40 of FIG. 12, a Web page or dialog box for indicating that the general check has been completed is displayed (step S42). FIG. 16 is a diagram depicting an example of the page used to indicate that the general check has been completed. In this example, the display indicates that no error has been found.

When the user clicks the element EL12 for indicating that a general check is to be performed, on the Web page (FIG. 4) in accordance with the general printer check in this manner, the corresponding auto execution module 400 is downloaded from the server 120 to the client 200, and the presence or absence of an error state in the printer 210 is detected by the auto execution module 400. The user can therefore easily identify a type of malfunction developed by the printer 210 by clicking the element EL12 when some malfunction occurs. If several malfunctions are detected, the display contains elements designed to indicate the subsequent troubleshooting procedures to be performed in order to deal with these malfunctions. The user can therefore easily deal with such malfunctions by clicking on the corresponding element.

D. Auto-Installation of Printer Driver

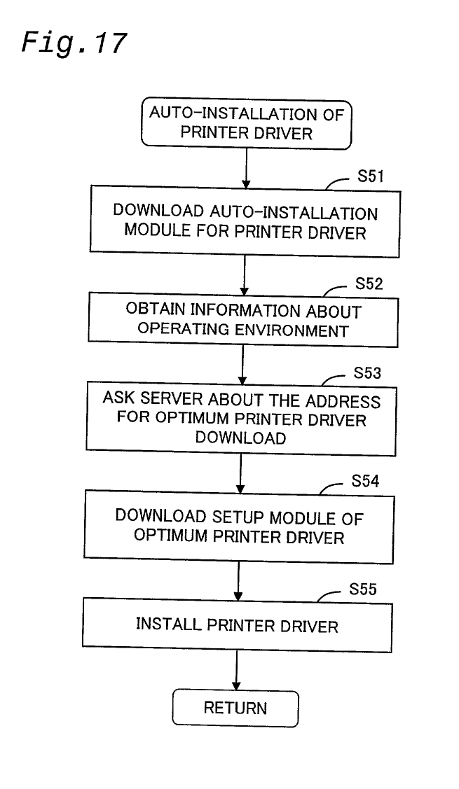

FIG. 17 is a flowchart depicting the procedure for the auto-installation of a printer driver. The procedure is started when the user clicks the second element EL2 in FIG. 3.

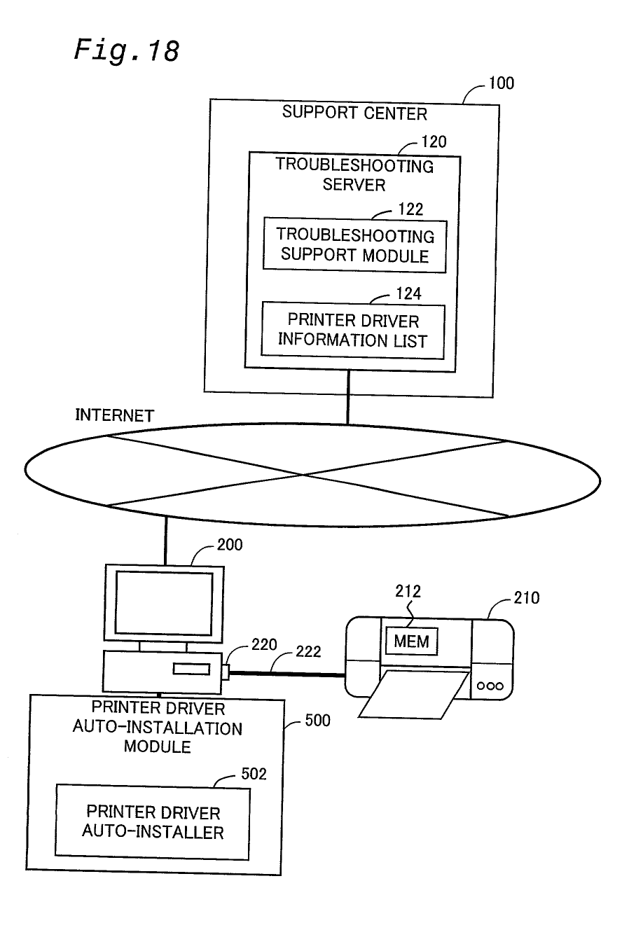

In step S51, a auto-installation module for the printer driver is downloaded from the troubleshooting server 120 to the client 200. FIG. 18 is a block diagram depicting the printer driver auto-installation module 500 when first downloaded to the client 200. The auto-installation module 500 has a printer driver auto-installer 502. The auto-installer 502 is automatically started when its downloading to the client 200 is completed. The auto-installer 502 may, for example, be created using Active X technology (trademark of Microsoft Corporation).

In step S52, information about the operating environment of the printer 210 is obtained by the auto-installer 502. As used herein, the term “information about the operating environment of the printer 210” refers to the information used to select a printer driver suitable for the printer 210. The information include the following items, for example:

(1) Type of printer 210

(2) Type and version of the operating system for the client 200

(3) Version of the printer driver 204 (FIG. 1) installed on the client 200

Information about the type of printer 210 is obtained from the memory 212 of the printer 210. Information about the printer driver 204 and the operating system for the client 200 is obtained from the registry and the system information of the client 200.

The auto-installer 502 presents the troubleshooting server 120 with the information about the printer operating environment thus obtained to inquire about an address of storage location of an optimum printer driver for the printer 210 (step S53). The troubleshooting support module 122 uses the information about the operating environment of the printer to scan a printer driver information list 124 (FIG. 18) and select the optimum printer driver for the printer 210. The information recorded in the printer driver information list 124 includes the relation between the operating environment of the printer and the newest version of the printer driver, and the storage location of the printer driver on the server 120. The troubleshooting support module 122 can therefore refer to the printer driver information list 124 and select the optimum printer driver for the printer 210. The troubleshooting support module 122 provides the auto-installer 502 with the storage address of the optimum printer driver thus selected.

In step S54, the auto-installer 502 accesses the storage address supplied by the troubleshooting support module 122 and downloads a module (setup module) for installing the optimum printer driver. If the optimum printer driver for the printer 210 is the same as the printer driver 204 (FIG. 1) already installed, a dialog box in which the user is asked about overwriting the printer driver should preferably be displayed before the downloading of the setup module is started. If the optimum printer driver for the printer 210 is a newer version than the already installed printer driver 204 (FIG. 4), a dialog box in which the user is asked whether or not to proceed the installation of the newer version of the printer driver may be displayed before the downloading of the setup module is started.

The term “new installation” will be hereinafter used for the initial installation of a printer driver to the client 200 and also for an installation in which an older version of a printer driver is updated. The term “overwrite installation” will be hereinafter used to indicate reinstalling a printer driver identical to the one already installed on the client 200.

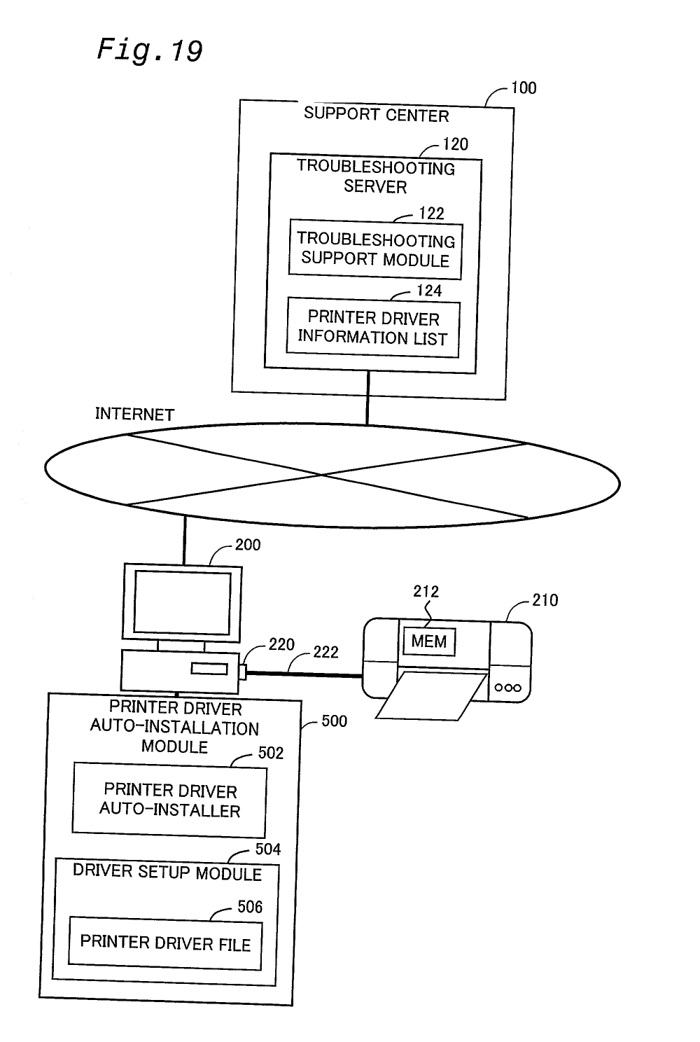

FIG. 19 depicts the structure of the auto-installation module 500 after the setup module has been downloaded. In FIG. 19, a setup module 504 including a printer driver file 506 has been added to the auto-installation module 500 shown in FIG. 18. The setup module 504 is an execution file (EXE file) for installing a printer driver on the client 200. The printer driver file 506 is the optimum printer driver for the printer 210.

The driver setup module 504 corresponds to the driver setup program in the claimed invention.

The auto-installer 502 starts the setup module 504 once the module 504 has been downloaded. The setup module 504 executes a procedure for installing the printer driver file 506 on the client 200 in step S55. For example, the existing printer driver is uninstalled, a new printer driver is installed, and the client 200 is restarted in the case of a new installation. A new printer driver is installed and the client 200 is restarted in the case of an overwrite installation. A dialog box in which the user is asked whether the restarting should be done immediately is typically displayed prior to restarting.

Thus, the auto-installer 502 of the printer driver downloads the optimum printer driver and its setup module 504 to the printer 210 and starts the setup module 504 by controlling the processing flow of steps S51-S54. The user can therefore easily install a printer driver suitable for the printer 210 merely by replying to a simple query as needed after clicking the element EL2 shown in FIG. 3. In other words, the advantage for the user is that an optimum printer driver can be installed even in the absence of any knowledge about the type of printer 210, the operating system of the client 200, and the currently used version of the printer driver.

According to the present embodiment, information about the various printer drivers suitable for the printer is summarized and registered in a printer driver information list 124 in the server 120. The administrator of the support center 100 can therefore provide the user with the newest printer driver merely by updating the information list 124 with the latest information. In other words, the present embodiment is advantageous in that it makes it easier to manage the information designed to support the downloading of a printer driver optimally suited to each equipment type.

Another advantage is that the volume of data in downloaded files can be reduced because the setup module 504 is downloaded from the server 120 to the client 200 after the optimum printer driver has been selected according to the procedure of FIG. 17.

E. Modifications

E1. Modification 1

Although the above embodiment is described with reference to a case in which a printer 210 is used as a peripheral device to be supported, it is also possible to adopt an arrangement in which a scanner, external memory device, or other type of peripheral devices is the object of support.

Although a parallel port 220 and cable 222 are used as the external interface, it is also possible to use any other external interface, such as a USB port or infrared interface, for connecting peripheral devices to the client device.

If the peripheral devices subject to support can be connected to any one of a plurality of external interfaces (for example, to a parallel port and a USB port) of the client 200, the external interface to which the peripheral device is actually connected should preferably be identified before any control signals are sent to the peripheral device. The identification procedure may, for example, be performed by a troubleshooting auto execution module downloaded from the server 120 to the client 200.

E2. Modification 2

The above embodiment is described with reference to the following four types of troubleshooting procedures: nozzle check pattern printing (element EL11 in FIG. 4), head cleaning (element EL12), general printer check (element EL13), and printer driver auto-install (element EL2 in FIG. 3). The present invention may be also adapted to various other troubleshooting procedures.

In the above examples of nozzle check patterns (FIGS. 5 and 8), the entire auto execution module 300 corresponds to the troubleshooting program of the present invention. In the above examples of general printer checks (FIGS. 12 and 14), the entire auto execution module 400 corresponds to the troubleshooting program of the present invention. In the above examples of printer driver auto-installations (FIGS. 17 and 19), the auto-installer 502 corresponds to the peripheral devices information acquisition program of the present invention, and the setup module 504 corresponds to a troubleshooting program. The information obtained by the peripheral devices information acquisition program should include at least data related to the type of the peripheral device.

E3. Modification 3

In the procedure shown in FIG. 17 and related to the auto-installation of a printer driver, the storage address of the optimum printer driver is notified from the server 120 to the client 200 when information about the operating environment of the printer is sent to the server 120 in step S53, and then the client 200 accesses this storage address in step S54. Alternatively, a driver setup module 404 containing the optimum printer driver may be transmitted from the server 120 to the client 200 when information about the operating environment of the printer is sent to the server 120 in step S53.

These examples demonstrate that either of the two following procedures can be adopted when information about peripheral devices is notified by a client to a server: (i) the server informs the client of the storage address of a suitable troubleshooting program, and the client then accesses the storage address; and (ii) the troubleshooting program is transmitted directly to the client without the server informing the client about the storage address for a suitable troubleshooting program. In the first procedure (i), the storage address of the troubleshooting program may be placed in a server which is different from the server the client initially accessed. Even in this case, it can be said that the client accesses the server in a broad sense. In short, the “server” of the present invention is not always placed in one place, but it may be constituted by a plurality of machines place in a plurality of places.

E4. Modification 4

The above embodiment may also be modified such that either the server 110 or the server 120 performs some of the functions of the client 200. Conversely, some of the functions of the server 110 or 120 may be performed by the client 200.

E5. Modification 5

When the client has already stored a necessary troubleshooting program, the client may send information about the stored troubleshooting program with the request for a troubleshooting program to the server system. This information preferably includes the type and version of the troubleshooting program. Upon receiving this kind of request, the server system may perform: (i) judging whether the stored troubleshooting program is its newest version according to the information about the stored troubleshooting program; and (ii) transmitting the newest version to the client only when the stored troubleshooting program is not the newest. If the stored troubleshooting program in the client is its newest version, the server system may not send the newest version but only send a message indicating that the stored program is the newest one to the client. This procedure can omit useless transmission of programs, thereby reducing the load on the overall network.

E6. Modification 6

The client of the present invention includes not only so-called computers, but also other devices and apparatuses containing a CPU and connected to an interactive communication network. The network may be connected by radio or by power lines. For example, household electric devices and electric appliances, such as TV sets and air conditioners, can act as a client. In a concrete example, when a TV set is connected to a video player with a hard disc drive, the TV set may act as a client for performing the troubleshooting of the video player. The troubleshooting may also be performed on the client itself. The “computer” in the present invention includes various devices and apparatuses having a CPU.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method, executed under control of a server system, for causing a client device connected to the sever system via a network to troubleshoot a peripheral device connected to the client device, the method comprising:
(a) transmitting to the client device a troubleshooting page containing a troubleshooting instruction element usable for inputting an instruction to execute a troubleshooting procedure to troubleshoot the peripheral device, thereby causing the client device to display the troubleshooting page;
(b) receiving a request for a troubleshooting program that is sent from the client device in response to selection of the troubleshooting instruction element on the troubleshooting page; and
(c) transmitting the troubleshooting program to the client device in response to the request for a troubleshooting program, thereby causing the client device to carry out the troubleshooting procedure by executing the troubleshooting program.

2. A method according to claim 1, wherein the troubleshooting program is automatically started after being downloaded onto the client device.

3. A method according to claim 1, wherein the peripheral device is connected to the client device via an external interface of the client device; and
wherein the step (c) includes step (c1) in which the troubleshooting program causes the peripheral device to perform a specific operation for the troubleshooting by providing the peripheral device with a control signal for controlling the peripheral device via the external interface.

4. A method according to claim 3, wherein the step (c) includes step (c2) which precedes the step (c1) and in which the troubleshooting program examines an external interface connected to the peripheral device and to the client device.

5. A method according to claim 3, wherein the step (c) includes step (c3) which precedes the step (c1) and in which the troubleshooting program determines whether the peripheral device is capable of executing the specific operation.

6. A method according to claim 5, wherein the step (c3) includes:
a step in which the troubleshooting program obtains error information that identifies an error state of the peripheral device from a memory inside the peripheral device; and
a step in which the troubleshooting program displays on the client device that the peripheral device is in an error state when the error information indicates that the peripheral device is in the error state.

7. A method according to claim 5, wherein the step (c3) includes:
a step in which the troubleshooting program determines whether the peripheral device corresponds to one of specific equipment types suitable for the troubleshooting procedure; and
a step in which the troubleshooting program displays on the client device that the peripheral device is not suitable for the troubleshooting procedure if the peripheral device does not correspond to any of the specific equipment types.

8. A method according to claim 1, wherein the step (c) includes a step in which the troubleshooting program displays a normal processing result and an abnormal processing result on the client device after the troubleshooting procedure is completed.

9. A method according to claim 8, wherein the display containing the normal and abnormal processing results is configured to further include a second troubleshooting instruction element usable for inputting an instruction to execute a second troubleshooting procedure when a result of the troubleshooting procedure that was initially performed corresponds to the abnormal processing result.

10. A method according to claim 1, wherein the step (c) includes:
a step in which the troubleshooting program obtains error information that identifies an error state of the peripheral device from a memory inside the peripheral device; and
a step in which the troubleshooting program displays on the client device that the peripheral device is in an error state when the error information indicates that the peripheral device is in the error state.

11. A method according to claim 1, wherein the step (c) includes:
a step in which the troubleshooting program determines whether the peripheral device corresponds to one of specific equipment types suitable for the troubleshooting procedure; and
a step in which the troubleshooting program displays on the client device that the peripheral device is not suitable for the troubleshooting procedure if the peripheral device does not correspond to any of the specific equipment types.

12. A method according to claim 1, wherein the step (b) comprises:
(b1) receiving a request for a peripheral device information acquisition program that is sent from the client device in response to the selection of the troubleshooting instruction element on the troubleshooting page;
(b2) transmitting the peripheral device information acquisition program to the client device in response to the request for a peripheral device information acquisition program, thereby causing the client device to execute the peripheral device information acquisition program to acquire peripheral device information containing data related to a type of the peripheral device, and to transmit the peripheral device information thus obtained to the server system;
(b3) receiving the peripheral device information; and
(b4) informing the client device of a storage address of a troubleshooting program suitable for the type of peripheral device indicated by the peripheral device information, thereby causing the client device to send the request for a troubleshooting program to the storage address thus informed.

13. A method according to claim 1, wherein the step (b) comprises:
(b1) receiving a request for a peripheral device information acquisition program that is sent from the client device in response to the selection of the troubleshooting instruction element on the troubleshooting page;
(b2) transmitting the peripheral device information acquisition program to the client device in response to the request for a peripheral device information acquisition program, thereby causing the client device to execute the peripheral device information acquisition program to acquire peripheral device information containing data related to a type of the peripheral device, and to transmit the peripheral device information thus obtained and the request for a troubleshooting program to the server system; and
(b3) receiving the peripheral device information and the request for a troubleshooting program,
wherein the step (c) comprises:
transmitting a troubleshooting program suitable for the type of peripheral device indicated by the peripheral device information to the client device.

14. A method according to claim 12, wherein the server system stores matching information indicating relation between a plurality of types of peripheral devices and a plurality of troubleshooting programs suitable for the plurality of types of peripheral devices, and refers to the matching information according to the peripheral device information provided by the client device to select the troubleshooting program suitable for the peripheral device connected to the client device.

15. A method according to claim 1, wherein the request for a troubleshooting program from the client device includes information about a stored troubleshooting program which is already stored in the client device,
and wherein the step (c) includes:
judging whether the stored troubleshooting program is a newest version of the program according to the information about the stored troubleshooting program;
if the stored troubleshooting program is not the newest version, transmitting the newest version to the client device; and
if the store troubleshooting program is the newest version, sending to the client device a message indicating that the store troubleshooting program is the newest version while not transmitting the newest version.

16. A method, executed under control of a server system, for causing a client device connected to the sever system via a network to install on the client device a driver program suitable for a peripheral device connected to the client device, the method comprising:
(a) transmitting to the client device a driver auto-installation page containing an instruction element usable for inputting an instruction to execute an auto-installation to install the driver program suitable for the peripheral device, thereby causing the client device to display the driver auto-installation page;
(b) receiving a request for a driver setup program that is sent from the client device in response to selection of the instruction element on the driver auto-installation page; and
(c) transmitting the driver setup program to the client device in response to the request for a driver setup program, thereby causing the client device to carry out installation of the driver program by executing the driver setup program.

17. A method according to claim 16, wherein the step (b) comprises:
(b1) receiving a request for a peripheral device information acquisition program that is sent from the client device in response to the selection of the instruction element on the driver auto-installation page;
(b2) transmitting the peripheral device information acquisition program to the client device in response to the request for a peripheral device information acquisition program, thereby causing the client device to execute the peripheral device information acquisition program to acquire peripheral device information containing data related to a type of the peripheral device, and to transmit the peripheral device information thus obtained to the server system;
(b3) receiving the peripheral device information; and
(b4) informing the client device of a storage address of a driver setup program including a driver program suitable for the type of peripheral device indicated by the peripheral device information, thereby causing the client device to send the request for a driver setup program to the storage address thus informed.

18. A method according to claim 16, wherein the step (b) comprises:
(b1) receiving a request for a peripheral device information acquisition program that is sent from the client device in response to the selection of the instruction element on the driver auto-installation page;
(b2) transmitting the peripheral device information acquisition program to the client device in response to the request for a peripheral device information acquisition program, thereby causing the client device to execute the peripheral device information acquisition program to acquire peripheral device information containing data related to a type of the peripheral device, and to transmit the peripheral device information thus obtained and the request for a driver setup program to the server system; and
(b3) receiving the peripheral device information and the request for a driver setup program,
wherein the step (c) comprises:
transmitting a driver setup program suitable for the type of peripheral device indicated by the peripheral device information to the client device.

19. A method according to claim 17, wherein the server system stores matching information indicating relation between a plurality of types of peripheral devices and a plurality of driver programs suitable for the plurality of types of peripheral devices, and refers to the matching information according to the peripheral device information provided by the client device to select the driver program suitable for the peripheral device connected to the client device.

20. A method, executed under control of a server system, for causing an electric device connected to the sever system via a network to carry out a troubleshooting procedure related to the electric device, the method comprising:
(a) receiving a request for a troubleshooting program that is sent from the electric device; and
(b) transmitting the troubleshooting program to the electric device in response to the request for a troubleshooting program, thereby causing the electric device to carry out the troubleshooting procedure by executing the troubleshooting program.

21. A method according to claim 20, wherein the troubleshooting program is configured to troubleshoot a peripheral device connected to the electric device.

22. A server system, connected to a client device via a network and used to troubleshoot a peripheral device connected to the client device, the server system comprising:
a storage device storing a troubleshooting page and a troubleshooting program, the troubleshooting page containing a troubleshooting instruction element usable for inputting an instruction to execute a troubleshooting procedure to troubleshoot the peripheral device, the troubleshooting program being configured to be executed by the client device in order to perform the troubleshooting procedure; and
a troubleshooting support section configured to transmit the troubleshooting program to the client device when receiving a request for a troubleshooting program that is sent from the client device in response to selection of the troubleshooting instruction element on the troubleshooting page.

23. A server system according to claim 22, wherein the troubleshooting support section is configured to receive, from the client device, peripheral device information containing data related to a type of the peripheral device, and to inform the client device of a storage address of a troubleshooting program suitable for the type of peripheral device indicated by the peripheral device information.

24. A server system according to claim 22, wherein the troubleshooting support section is configured to receive, from the client device, peripheral device information containing data related to a type of the peripheral device, and to transmit a troubleshooting program suitable for the type of peripheral device indicated by the peripheral device information to the client device.

25. A server system according to claim 23, wherein the troubleshooting support section stores matching information indicating relation between a plurality of types of peripheral devices and a plurality of troubleshooting programs suitable for the plurality of types of peripheral devices, and refers to the matching information according to the peripheral device information provided by the client device to select the troubleshooting program suitable for the peripheral device connected to the client device.

26. A server system according to claim 22, wherein the request for a troubleshooting program from the client device includes information about a stored troubleshooting program which is already stored in the client device,
and wherein the troubleshooting support section includes:
means for judging whether the stored troubleshooting program is a newest version of the program according to the information about the stored troubleshooting program;
means for, if the stored troubleshooting program is not the newest version, transmitting the newest version to the client device; and
means for, if the store troubleshooting program is the newest version, sending to the client device a message indicating that the store troubleshooting program is the newest version while not transmitting the newest version.

27. A server system, connected to a client device via a network and used to install on the client device a driver program suitable for a peripheral device connected to the client device, the server system comprising:
a storage device storing a driver auto-installation page and a driver setup program, the driver auto-installation page containing an instruction element usable for inputting an instruction to execute an auto-installation procedure to install the driver program suitable for the peripheral device, the driver setup program being configured to be executed by the client device in order to perform the auto-installation procedure of the driver program; and
a driver setup support section configured to transmit the driver setup program to the client device when receiving a request for a driver setup program that is sent from the client device in response to selection of the instruction element on the driver auto-installation page.

28. A server system according to claim 27, wherein the driver setup support section is configured to receive, from the client device, peripheral device information containing data related to a type of the peripheral device, and to inform the client device of a storage address of a driver setup program including a driver program suitable for the type of peripheral device indicated by the peripheral device information.

29. A server system according to claim 27, wherein the driver setup support section is configured to receive, from the client device, peripheral device information containing data related to a type of the peripheral device, and to transmit a driver setup program including a driver program suitable for the type of peripheral device indicated by the peripheral device information to the client device.

30. A server system according to claim 27, wherein the driver setup support section stores matching information indicating relation between a plurality of types of peripheral devices and a plurality of driver programs suitable for the plurality of types of peripheral devices, and refers to the matching information according to the peripheral device information provided by the client device to select the driver program suitable for the peripheral device connected to the client device.

31. A computer readable medium storing a server program for a server system connected to a client device via a network, the server program causing the server system to provide support to the client device in order to troubleshoot a peripheral device connected to the client device, the server program comprising:
a first program for causing the server system to receive a request for a troubleshooting program that is sent from the client device in response to selection of a troubleshooting instruction element on a troubleshooting page displayed on the client device; and
a second program for causing the server system to transmit the troubleshooting program to the client device in response to the request for a troubleshooting program.

32. A computer readable medium storing a server program for a server system connected to a client device via a network, the server program causing the server system to provide support to the client device in order to install on the client device a driver program suitable for a peripheral device connected to the client device, the server program comprising:
a first program for causing the server system to receive a request for a driver setup program that is sent from the client device in response to selection of an instruction element on a driver auto-installation page displayed on the client device; and
a second program for causing the server system to transmit the driver setup program to the client device in response to the request for a driver setup program.

33. A computer readable medium storing a client program for a client device, the client program being configured to be transmitted to the client device from a server system via a network, the client program comprising:
a first program that is automatically started and executed upon completion of transmission from the server system to the client device, and is configured to cause the client device to carry out a specific procedure to troubleshoot a peripheral device connected to the client device.
